(19) United States
(12) Patent Application Publication
(10) Pub. No.: US 2022/0366487 A1
(43) Pub. Date: Nov. 17, 2022

(54) METHOD FOR DETERMINING VALUE AND TRADING IN A COMPETITIVE MARKETPLACE

(71) Applicant: Trading Players, LLC, Eugene, OR (US)

(72) Inventors: Kenneth Pendleton, Eugene, OR (US); David Galas, Eugene, OR (US); Steven S. Hubbard, Lake Oswego, OR (US)

(21) Appl. No.: 17/878,369

(22) Filed: Aug. 1, 2022

Related U.S. Application Data
(63) Continuation of application No. 16/223,542, filed on Dec. 18, 2018, now abandoned.
Application No. 16/223,542 is a continuation-in-part of application No. 13/681,418, filed on Nov. 19, 2012, now abandoned.
(60) Provisional application No. 61/629,263, filed on Nov. 17, 2011.

(51) Int. Cl. G06Q 30/08; G07F 17/32

(52) U.S. Cl. CPC G06Q 30/08; G07F 17/3237

(57) ABSTRACT

A method and system for generating an interactive gaming platform is disclosed herein. A computing system generates an interactive marketplace. The computing system generates an initial book value based at least on historical performance of each athlete. The computing system generates an interactive game space for each event. The computing system monitors, for each event, one or more external data sources to identify one or more fantasy points scored by each player in the subset of players. The computing system generates a percentage of fantasy points earned in relation to subset of players associated with the event. The computing system allocates, for each event, the event pool to each player in accordance with the percentage of fantasy points earned by each player to generate a post-event book value.

### FIELD OF DISCLOSURE

The present disclosure generally relates to method and system for generating an interactive gaming platform.

### BACKGROUND

A variety of attempts have been made to set up interactive marketplaces for sports, using either real cash investment or other investment substitutes. One prior attempt based the marketplace prices entirely on supply and demand with no real underlying value (like trading baseball cards), which means that players' stocks have no objective or intrinsic value. This approach led to predictable problems with unfettered speculation and rapid collapse.

One attempt has been made which tried to create a true market by merely setting an initial price (or book value) for each listed athlete. This attempt used a zero-sum-game model to measure the relative worth or contribution but did not redistribute value or worth based on each game or contest. Instead, all of the money remained in one pool and the per share value of Athletes could rise or fall when that Athlete played in a Game but always fell when other Games occurred because other athletes were accumulating points and thus adding value.

### SUMMARY

In some embodiments, a system is disclosed herein. The system includes a processor and a memory. The memory having programming instructions stored thereon, which, when executed by the processor performs one or more operations. The one or more operations include generating an interactive marketplace. The interactive marketplace is defined by one or more eligible players and a specified period. The specified period includes one or more events. The one or more operations further include generating an initial book value based at least on historical performance of each athlete. The one or more operations further include generating an interactive game space by for each event. The interactive game space may be generated by identifying a subset of players associated with the event, risking a predefined percentage of the initial book value of each player in the subset of players, and generating an event pool by summing a total amount of the initial book value waged by each player in the subset of players. The one or more operations further include monitoring, for each event, one or more external data sources to identify one or more fantasy points scored by each player in the subset of players. The one or more operations further include generating, for each player at a conclusion of each event, a percentage of fantasy points earned in relation to subset of players associated with the event. The one or more operations further include allocating, for each event, the event pool to each player in accordance with the percentage of fantasy points earned by each player to generate a post-event book value.

In another embodiment, a computer-implemented method of generating an interactive gaming platform is disclosed herein. A computing system generates an interactive marketplace. The interactive marketplace is defined by one or more eligible players and a specified period. The specified period includes one or more events. The computing system generates an initial book value based at least on historical performance of each athlete. The computing system generates an interactive game space for each event. The computing system identifies a subset of players associated with the event. The computing system risks a predefined percentage of the initial book value of each player in the subset of players. The computing system generates an event pool by summing a total amount of the initial book value wagered by each player in the subset of players. The computing system monitors, for each event, one or more external data sources to identify one or more fantasy points scored by each player in the subset of players. The computing system generates, for each player at a conclusion of each event, a percentage of fantasy points earned in relation to subset of players associated with the event. The computing system allocates, for each event, the event pool to each player in accordance with the percentage of fantasy points earned by each player to generate a post-event book value.

In another embodiment, a non-transitory computer readable medium is disclosed herein. The non-transitory computer readable medium includes one or more sequences of instructions, which, when executed by one or more processors, cause the one or more processors to perform one or more operations. The one or more operations include generating an interactive marketplace. The interactive marketplace is defined by one or more eligible players and a specified period. The specified period includes one or more events. The one or more operations further include generating an initial book value based at least on historical performance of each athlete. The one or more operations further include generating an interactive game space for each event by identifying a subset of players associated with the event, risking a predefined percentage of the initial book value of each player in the subset of players, and generating an event pool by summing a total amount of the initial book value waged by each player in the subset of players. The one or more operations further include monitoring, for each event, one or more external data sources to identify one or more fantasy points scored by each player in the subset of players. The one or more operations further include generating, for each player at a conclusion of each event, a percentage of fantasy points earned in relation to the subset of players associated with the event. The one or more operations further include allocating, for each event, the event pool to each player in accordance with the percentage of fantasy points earned by each player to generate a post-event book value.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrated only typical embodiments of this disclosure and are therefore not to be considered limiting of its scope, for the disclosure may admit to other equally effective embodiments.

FIG. 1 is a block diagram illustrating a computing environment, according to example embodiments.

FIG. 2 is a block diagram illustrating interactive gaming platform of FIG. 1, according to example embodiments.

FIG. 3 is a block diagram illustrating one or more stages within a specified period, according to example embodiments.

FIG. 4 is a flow diagram illustrating a method of generating a book value for each eligible athlete, according to example embodiments.

FIG. 5A is a block diagram illustrating a graphical user interface, according to example embodiments.

FIG. 5B is a block diagram illustrating a graphical user interface, according to example embodiments.

FIG. 5C is a block diagram illustrating a graphical user interface, according to example embodiments.

FIG. 5D is a block diagram illustrating a graphical user interface, according to example embodiments.

FIG. 6 is a block diagram illustrating a graphical user interface, according to example embodiments.

FIG. 7 is a flow diagram illustrating a method of conducting an event in a virtual game space, according to example embodiments.

FIG. 8A is a block diagram illustrating a graphical user interface, according to example embodiments.

FIG. 8B is a block diagram illustrating a graphical user interface, according to example embodiments.

FIG. 9 is a block diagram illustrating a computing environment, according to example embodiments.

### DETAILED DESCRIPTION

One or more techniques described herein relate to an interactive gaming platform hosting one or more interactive marketplaces based on the actual performance of participants in any type of competitive game or situation.

This one or more techniques described herein creates one or more dynamic marketplaces where market participants can fantasy cash or (to the extent legally permitted) actual cash in virtual “shares” of participants in underlying competitive contests (such participants, the “Athletes”). A market participant may invest in one or more Athletes, with his investment in each representing an investment in such Athlete's expected on-field performance in the applicable underlying competitive contest/s (each such investment, a “Stock”). Markets may be set up for the issuance and trading of Stocks for particular sports covering individual seasons, portions of a season (such a post-season playoffs), a specific event (such as the Olympics), or multiple seasons (each such market, a “Marketplace”). During the specified period of a Marketplace, the Stocks will trade in a manner similar to actual stocks. At the conclusion of the applicable period (or, in the case of multi-season marketplaces, when a player retires) the final value of each Stock will be determined by the Stock's closing “book value”—an objective measurement specified in advance by each Marketplace which relies on a combination of traditional fantasy sports league performance scoring (or other appropriate measurements) for the applicable Athlete and the book value determination methodology outlined below.

In some embodiments, for each Marketplace, the system may generate an initial book value for all athletes. For example, the system may use historical performances of each player, as well as data from one or more external data sources, to generate the initial book value for each athlete. The sum of all book values may be the initial amount of the book value for the Marketplace (the “Marketplace Book Value”).

In some embodiments, for each Marketplace, the system may leverage a onetime initial public offering (an “IPO”) for all Athletes. The amount invested by market participants in fantasy points, fantasy cash or (if applicable) actual cash (the “Value”) during the IPO process may aid in determining the initial book values used in the Marketplace. For example, the system may generate an initial book value for all athletes using an analysis of historical player performance as well as external data, and adjust the initial book value based on the IPO. Once the initial IPO process is done, the Marketplace Book Value may be fixed (unless the Marketplace offers periodic new IPOs for Athletes not previously subject to one, with any Value added during such IPO then increasing the Marketplace Book Value) but the Athlete Book Value will fluctuate based on relative performance.

For each competitive contest covered by a Marketplace, the Marketplace will specify a percentage of Athlete Book Value at risk in such contest. Each Athlete who participates in such contest will be deemed to contribute the specified percentage (e.g. 10%) of his Athlete Book Value to a pool of book value associated with that contest (the “Game Pool”). Following the conclusion of the contest, the Game Pool will be distributed to the Athlete Book Values of each participant Athlete depending on his performance (measured by objective fantasy sports league points or other appropriate measurement criteria) relative to other Athletes in the contest on a zero-sum basis.

Since Athletes are deemed to contribute a percentage of their Athlete Book Value in each game they are scheduled to participate, this system encourages investors to evaluate each player's likely game performance, which stimulates trading activity around each single game or contest. In addition, this approach means that market participants are not penalized if their Stocks represent Athletes who are injured or otherwise not selected for a contest, and allows the Athlete Book Value for Athletes whose team is not participating in a contest to remain unaffected, with relative decline only possible to the extent the Athlete Book Value of participants in a contest increases/decreases due to such Athletes' objective performance relative to other participant Athletes in such contest. The latter is particularly important as it allows a

Marketplace to track performance in post-season play without disadvantaging Athletes whose teams did not qualify for the applicable playoff structure. Furthermore, because no Athlete Book Value can decline to zero and only a percentage is contributed to any given Game Pool a player with very low Athlete Book Value can easily increase such book value with a single outstanding performance which increases the applicable Athlete Book Value dramatically.

Market participants will be allowed to trade Stocks through the Marketplace and exchange them with willing market participants for Value over the course of each Marketplace's specified period. Marketplaces may or may not place various restrictions on the Value market participants may invest in IPOs versus Value used to purchase Stocks and may also specify limits or prohibitions on market participants ability to extract Value from the Marketplace prior to the conclusion of its specified period. Due to the fact that each Marketplace will support active trading in Stocks, market participants will be able to employ many of the same approaches used in securities trading over the life of the Marketplace. At the same time, the Athlete Book Value concept provides an objective baseline creating structure in the market, reflecting relative performance and allowing for a final determination of Value.

At the conclusion of the period specified in advance by each Marketplace (or, in the case of multi-season Marketplaces, when an Athlete retires) the Value of the investment of each Market Participant in his or her Stocks will be the final Athlete Book Values reflected in such Stocks. In accordance with applicable law and as specified in advance by each Marketplace, the final distribution of Value may give market participants the traditional excitement of doing well in a fantasy sports contest, a valuable educational experience demonstrating through familiar sports how established real-world securities markets work, non-cash prizes or cash.

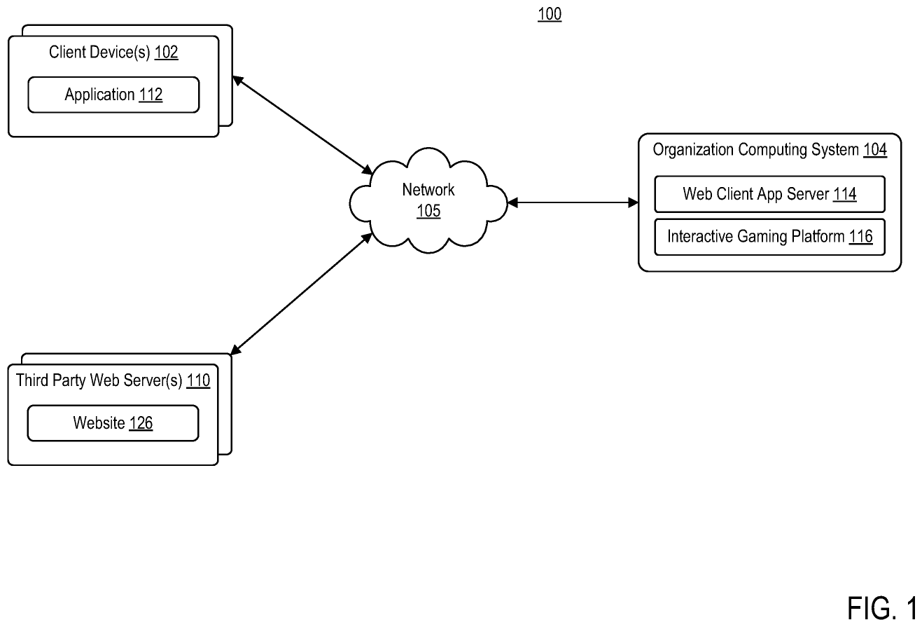

FIG. 1 is a block diagram illustrating a computing environment 100, according to one embodiment. Computing environment 100 may include at least one or more client devices 102, an organization computing system 104, and one or more external data sources 106 communicating via network 105.

Network 105 may be of any suitable type, including individual connections via the Internet, such as cellular or Wi-Fi networks. In some embodiments, network 105 may connect terminals, services, and mobile devices using direct connections, such as radio frequency identification (RFID), near-field communication (NFC), Bluetooth™, low-energy Bluetooth™ (BLE), Wi-Fi™ ZigBee™, ambient backscatter communication (ABC) protocols, USB, WAN, or LAN. Because the information transmitted may be personal or confidential, security concerns may dictate one or more of these types of connection be encrypted or otherwise secured. In some embodiments, however, the information being transmitted may be less personal, and therefore, the network connections may be selected for convenience over security.

Network 105 may include any type of computer networking arrangement used to exchange data. For example, network 105 may include any type of computer networking arrangement used to exchange information. For example, network 105 may be the Internet, a private data network, virtual private network using a public network and/or other suitable connection(s) that enables components in computing environment 100 to send and receiving information between the components of system 100.

Client device 102 may be operated by a user. For example, client device 102 may be a mobile device, a tablet, a desktop computer, or any computing system having the capabilities described herein. Client device 102 may belong to or be provided to a user or may be borrowed, rented, or shared. Users may include, but are not limited to, individuals such as, for example, subscribers, clients, prospective clients, or customers of an entity associated with organization computing system 104, such as individuals who may participate in an interactive gaming platform managed by organization computing system 104.

Client device 102 may include at least application 112. Application 112 may be representative of a web browser that allows access to a website or a stand-alone application. Client device 102 may access application 112 to access functionality of organization computing system 104. Client device 102 may communicate over network 105 to request a webpage, for example, from web client application server 114 of organization computing system 104. For example, client device 102 may be configured to execute application 112 to access content managed by web client application server 114. The content that is displayed to client device 102 may be transmitted from web client application server 114 to client device 102, and subsequently processed by application 110 for display through a graphical user interface (GUI) of client device 102.

Organization computing system 104 may include web client application server 114 and interactive gaming platform 116. Interactive gaming platform 116 may be configured to generate and manage an interactive and social gaming experience for end users. Interactive gaming platform 116 may be representative of one or more computing devices. For example, interactive gaming platform 116 may be representative of a distributed computing system, wherein each device of the distributed computing system may act as a host for one or more virtualization elements (e.g., OS-level virtualization elements, hardware-level virtualization elements) that include one or more modules or engines for facilitating and managing the interactive social gaming experience for end users.

In some embodiments, interactive gaming platform 116 may be configured to manage one or more skill-based fantasy sport games. For example, interactive gaming platform 116 may be configured to generate a virtual sport-based marketplace that facilitates a fantasy sports competition. Users (e.g., client device 102 may register and/or login with interactive gaming platform 116 to gain access to the virtual sports-based marketplace. Upon registering and/or logging in, client device 102 (e.g., a market participant) may invest in one or more athletes. Such investment may be tied to an athlete's (or player's) on-field performance in a competitive contest. The virtual sports-based marketplace may be configured for the issuance and trading of “stocks” (i.e., shares of an athlete/player) for particular sports covering individual seasons, portions of a season (e.g., post-season, playoffs, half-season, quarter-season, daily fantasy), a specific event (e.g., Olympics, golfing majors, tennis majors, etc.), multiple seasons, and the like. During each specified period, users may trade stock in a manner similar to financial instruments. A more detailed discussion of the game may be found below.

Organization computing system 104 may be in communication with one or more external data sources 106. One or more external data sources 106 may be configured to monitor one or more sporting events. In some embodiments, one or more external data sources 106 may be configured to monitor one or more sporting events in real-time (or near real-time). Each data source 106 may be configured to provide live data feeds to organization computing system 104, such that organization computing system 104 can monitor player performance. In some embodiments, one or more data sources 106 may transmit one or more live data feeds to organization computing system 104 via one or more application programming interfaces (APIs) defined by organization computing system 104. For example, organization computing system 104 may utilize one or more representational state transfer (REST) APIs with one or more endpoints defined at each of the one or more external data sources 106. In some embodiments, rather than provide the data feeds to organization computing system 104 in real-time (or near real-time), one or more external data sources 106 may transmit one or more sets of data feeds periodically (e.g., end of first quarter, end of first half, end of round 1, at the ninth hole, etc.).

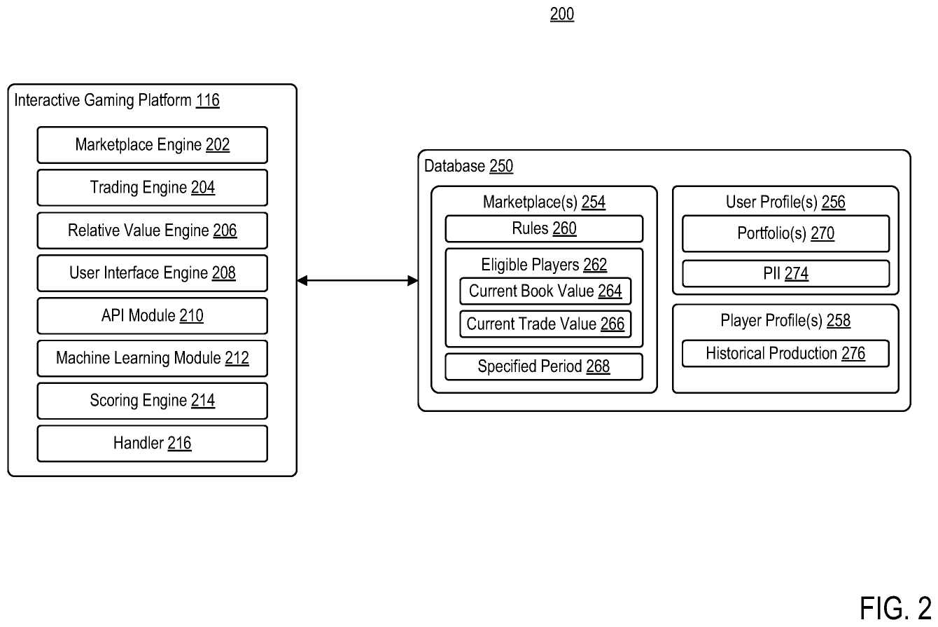

FIG. 2 is a block diagram illustrating one or more components of interactive gaming platform 116, according to example embodiments. Interactive gaming platform 116 may include a marketplace engine 202, a trading engine 204, a relative value engine 206, a user interface engine 208, an API module 210, a machine learning module 212, a scoring engine 214, and handler 216. Each of marketplace engine 202, trading engine 204, relative value engine 206, user interface engine 208, API module 210, machine learning module 212, scoring engine 214, and handler 216 may be comprised of one or more software modules. The one or more software modules may be collections of code or instructions stored on a media (e.g., memory of organization computing system 104) that represent a series of machine instructions (e.g., program code) that implements one or more algorithmic steps. Such machine instructions may be the actual computer code the processor of organization computing system 104 interprets to implement the instructions or, alternatively, may be a higher level of coding of the instructions that is interpreted to obtain the actual computer code. The one or more software modules may also include one or more hardware components. One or more aspects of an example algorithm may be performed by the hardware components (e.g., circuitry) itself, rather as a result of an instructions.

Marketplace engine 202 may be configured to initialize a marketplace for use in interactive gaming platform 116. For example, for a given sport and a given period, marketplace engine 202 may define the marketplace for use in a virtual game defined by the sport and period. In some embodiments, marketplace engine 202 may define a pool of eligible athletes/players that may participate in the virtual game. Generally, marketplace engine 202 may include in the pool of eligible athletes/players only those positions that are capable of scoring a point in an event. For example, when the sport is basketball, the pool of eligible players may include the roster of every team in the basketball league. In another example, when the sport is football, the pool of eligible players may include those players that play a position that is capable of scoring a fantasy point. Such players may include offensive players (minus the offensive line) and team defenses. In some embodiments, such players may include defensive players in addition to the offensive players.

Marketplace engine 202 may generate an initial book value for each eligible athlete. The initial book value may be a quantitative/numerical value assigned to each eligible athlete in the marketplace prior to the market opening. For example, given 575 eligible athletes in a football virtual game, marketplace engine 202 may assign to each eligible athlete a value between 0.01 and 5. Marketplace engine 202 may generate the initial book value using a prediction model generated by machine learning module 212. For example, marketplace engine 202 may generate the initial book value of each athlete based on historical performance of each athlete, historical performance of each athlete relative to other eligible athletes, third-party rankings, and the like. At the outset, all shares of each eligible player may be owned by organization computing system 104. If, for example, one multiplies the number of shares times the initial share price of each athlete's shares and sums each of those totals, which would yield the value of the marketplace. Organization computing system 104 may, in effect, be responsible to pay out the value at the end of the season. If organization computing system 104 owns any shares at the end of the season then organization computing system 104 may pay itself for those shares owned.

In some embodiments, marketplace engine 202 may adjust the initial book value by initiate an initial public offering (IPO) auction for each eligible athlete. For example, marketplace engine 202 may initiate an IPO auction to establish a book value for each athlete based on the initial book value and participant (i.e., end user) demand. In the IPO auction, marketplace engine 202 may sell stocks related to each eligible athlete. The initial price of the shares may be based off the initial book value generated by marketplace engine 202. At the end of the auction, each user that bid on the stock may pay the same price for the stock, based on the lowest winning bid. Marketplace engine 202 may distribute shares to each user based on each end user's big at the lowest winning bid price. The fluctuation of the initial book value during the IPO auction may define the book value of the athlete at the beginning of the specified period.

Machine learning module 212 may include one or more instructions to train a prediction model used by marketplace engine 202. To train the prediction model, machine learning module 212 may receive, as input, historical data associated with a particular athlete/player. The one or more streams of user activity may correspond to historical statistics of the particular athlete/player. In some embodiments, the one or more streams of user activity may correspond to historical statistics of athletes/players in the same sport or event. Still further, in some embodiments, the one or more steams of user activity may correspond to historical book values for one or more players in one or more previous specified periods. Such streams of activity may include historical book value, historical trading value, statistics in a given season, statistics in a given event, and the like. In some embodiments, machine learning module 212 may further receive, as input, one or more data streams from one or more third-party fantasy sport providers. For example, machine learning module 212 may take into account a fantasy football ranking of an individual on ESPN, Yahoo, DraftKings, and the like. As such, machine learning module 212 may leverage platform-generated data, in-game statistical data, and third-party data to generate each athlete's/players initial book value. Machine learning module 120 may implement one or more machine learning algorithms to train the prediction model. For example, machine learning module 120 may use one or more of a decision tree learning model, association rule learning model, artificial neural network model, deep learning model, inductive logic programming model, support vector machine model, clustering mode, Bayesian network model, reinforcement learning model, representational learning model, similarity and metric learning model, rule based machine learning model, and the like.

Marketplace engine 202 may be configured to facilitate end user gameplay throughout the specified period. Each specified period may include one or more playable events. For example, assuming the specified period is defined as a football regular season, the one or more playable events are the games within the football regular season. In another example, assuming the specified period is the Eastern Conference Finals in basketball, the one or more playable events are the games in the best-of-seven conference finals. As those skilled in the art recognize, at any given time in the specified period, multiple events may be conducted. For example, on a given Sunday, multiple football games may occur at a given moment.

Marketplace engine 202 may define one or more measurable events for each specified period. In other words, marketplace engine 202 may define one or more measurable events that occur within a given event, for which an athlete may earn or lose fantasy points. For example, in a specified period for football, marketplace engine 202 may assign six points to a rushing touchdown, six points to a throwing touchdown, one point per reception, negative two points for an interception, and the like.

For each event, marketplace engine 202 may generate an interactive game space. Within the interactive game space, marketplace engine 202 may risk a predefined portion of each athlete's book value prior to the start of the event. In some embodiments, marketplace engine 202 may risk a predefined percentage of each athlete's book value. For example, marketplace engine 202 may risk 10% of each athlete's book value for a given event. Accordingly, if Team A is playing Team B, all eligible players on both Team A and Team B have to risk X % of their book value. At the conclusion of the event, marketplace engine may redistribute the sum of all the risked book values to each athlete based on the percentage of fantasy points each athlete earned.

Trading engine 204 may be configured to facilitate trades of stock among one or more end users. For example, trading engine 204 may be configured to manage the day-to-day trading of players among one or more end users. In operation, a user may request to sell their stock or buy stock in various eligible players. To buy a stock, an end user may submit a bid price and a quantity of shares they wish to purchase. Trading engine 204 may process the submitted information and post the bid to the marketplace. To sell a stock, an end user may submit an ask price and a quantity of shares they wish to sell. Trading engine 204 may process the submitted information and post the ask to the marketplace.

Scoring engine 214 may be configured to communicate with one or more external sources 106. For example, scoring engine 214 may be configured to receive one or more data streams from one or more external sources 106. Such data streams may represent statistics associated with the measurable events for the specified period. Scoring engine 214 may be configured to analyze the data streams, and assign a numerical value to each measureable event defined by marketplace engine 202. For example, scoring engine 214 may assign six points to the athlete that scored a rushing touchdown. In another example, scoring engine 214 may assign three points to the athlete who successfully kicked a field goal. In other words, scoring engine 214 may assign a fantasy points value to one or more identified measurable events. At the end of each event, scoring engine 214 may sum the total points earned by each eligible participant (e.g., three rushing touchdowns may yield 18 points).

API module 210 may include one or more instructions to execute one or more APIs that provide various functionalities related to the operations of interactive gaming platform 116. In some embodiments, API module 210 may include an API adapter that allows API module 210 to interface with and utilize enterprise APIs maintained by interactive gaming platform 116 and/or an associated entity that may be homed on other systems or devices. In some embodiments, APIs may enable functions that include, for example, allowing one or more external data sources 106 to seamlessly provide live data streams interactive gaming platform 116 for processing. For example, API module 210 may define one or more API endpoints at each of the one or more data sources 106, such that one or more REST APIs generated by API module 210 may access live data feeds.

Relative value engine 206 may be configured to redistribute the amount risked in each game among the eligible athletes in the game. In some embodiments, relative value engine 206 may redistribute the amount risked in the game, based, in part, on the percentage of fantasy points each athlete earns in the event. Such redistribution is possible due to the zero-sum aspect of interactive gaming platform 116.

User interface engine 208 may be configured to generate one or more graphical user interfaces (GUIs). For example, user interface engine 208 may be configured to generate one or more GUIs for use with interactive gaming platform 116. In some embodiments, user interface engine 208 may generate one or more GUIs for one or more web pages hosted by web client application server 114

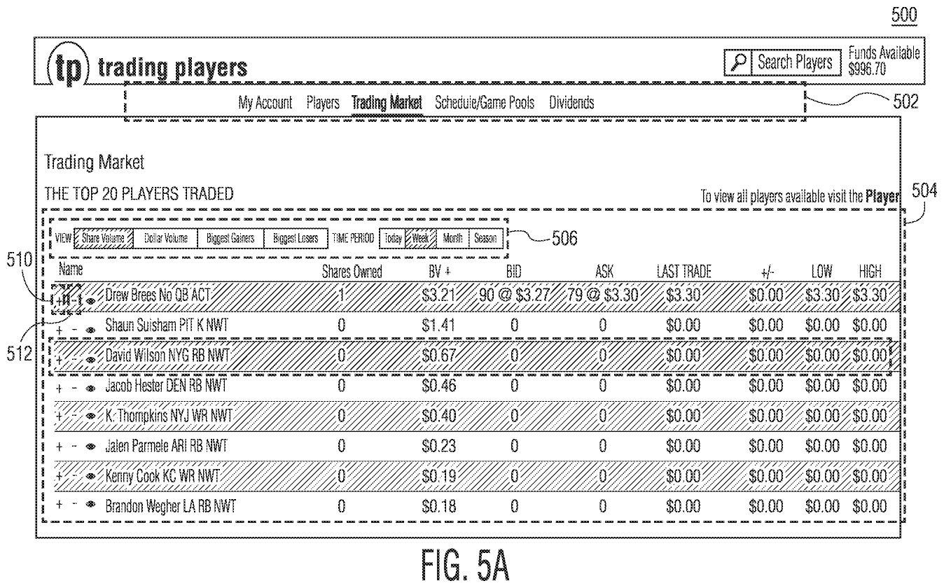

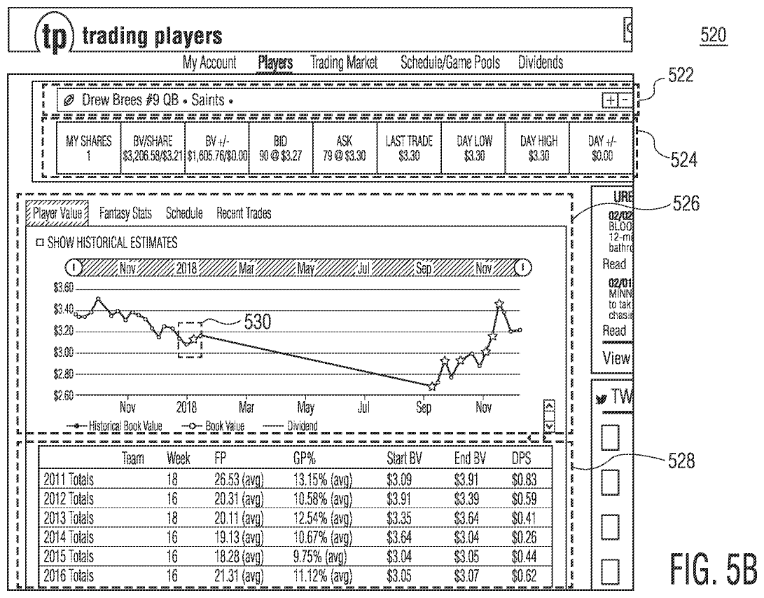

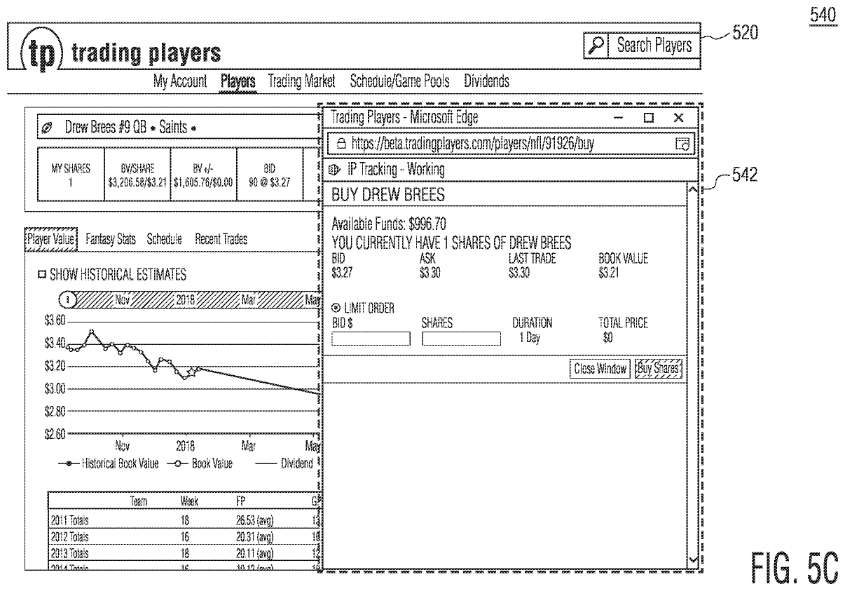

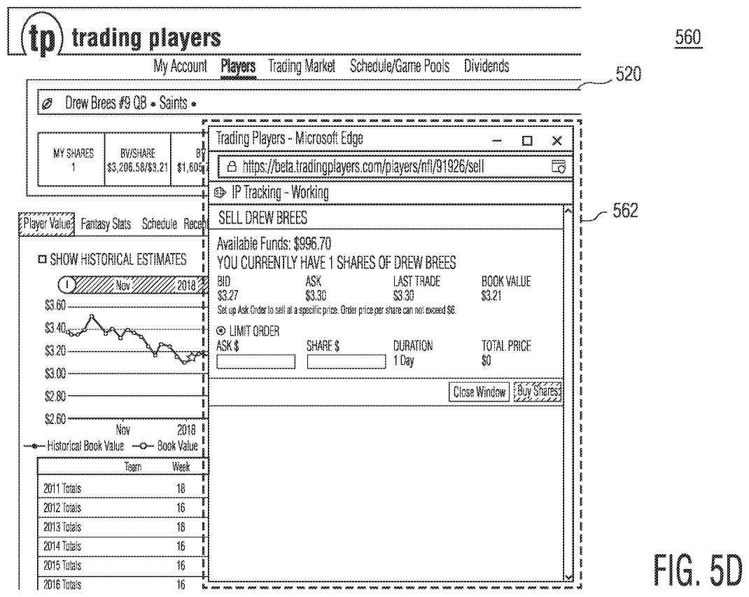

For example, user interface engine 208 may be configured to generate one or more GUIs discussed below in conjunction with FIGS. 5A-6, 8A, and 8B.

Account handler 116 may be configured to manage an account associated with each user. For example, account handler 116 may be configured to communicate with database 250. As illustrated, database 250 may include one or more marketplaces 254, one or more user profiles 256, and one or more player profiles 258.

Each marketplace 254 may be representative of a marketplace generated by marketplace engine 202. Generally, each marketplace 254 may represent a given virtual game space one or more users may join. For example, a marketplace may be created for almost any event that has multiple occurrences and for which objective measures of performance may be found. Using an example not related to sports, an exemplary marketspace may be created for a television game show contest. In some examples, the number of downloads of each performance in the contest may be the measure of the performance. In some examples, the number of user votes received during the contest may be the measure of performance. One or more marketplaces 254 may also include professional basketball marketplaces, college basketball marketplaces, professional baseball marketplaces, college football marketplaces, professional football marketplaces, professional hockey marketplaces, college hockey marketplaces, golfing marketplaces, soccer marketplaces, and the like. Each marketplace 254 may include one or more parameters associated therewith. For example, as illustrated, each marketplace 254 may include rules 260, eligible players 262, and a specified period 268.

Rules 260 may be representative of one or more rules associated with gameplay in marketplace 254. For example, rules 260 may include one or more measurable events and points associated with each measureable event. Rules 260 may further include a definition of what constitutes an eligible player for purposes of gameplay (e.g., which players have the ability to register points during game play).

Eligible players 262 may include a list of all eligible players for the marketplace. In some embodiments, eligible players 262 may refer to those players which are able to score a point during game play. Each eligible player 262 may include a current book value 264 and a current trade value 266. Current book value 264 may represent the book value of an eligible player at a given time. Current book value 264 may be based on the initial book value generated by marketplace engine 202. The eligible player's book value may fluctuate over time, based entirely on the player's performance in one or more events. Current trade value 266 may represent the trade value of an eligible player at a given time. Current trade value 266 may not be based on the player's performance, but rather, on the market demand, driven by expected future performance, for the player.

Specified period 268 may correspond to the period specified for gameplay. For example, specified period 268 may be an entire season, multiple seasons, a portion of a season, the postseason, a golfing major, a tennis major, and the like. Specified period 268 may include one or more events. End users may wager a predefined portion of each eligible player's book value in each event.

Each user profile 128 may correspond to a user with an account with organization computing system 104. Each user profile 128 may include one or more portfolios 270 and personal identification information 274. Each portfolio 270 may correspond to a user's stocks with a particular marketplace. For each, portfolio 270 may include one or more shares of one or more players. Personal identification information 274 may include information associated with the user. In some embodiments, personal identification information 274 may include a name, home address, billing address, mailing address, telephone number, e-mail address, social security number, and the like.

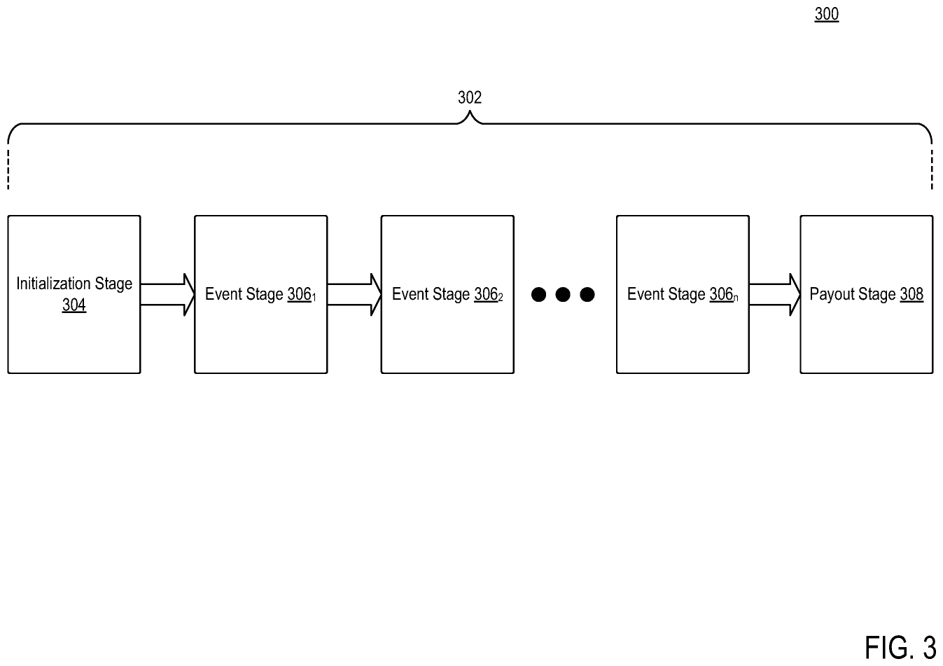

FIG. 3 is a block diagram illustrating one or more stages within a specified period, according to example embodiments. As illustrated, a specified period 302 may include an initialization stage 304, one or more event stages (e.g., game pools) 306₁, 306₂ . . . 306ₙ (generally “event stage 306”), and a payout stage 308. During initialization stage 304, marketplace engine 202 may define the pool of eligible players and generate an initial book value for each eligible player. In some embodiments, initialization stage 304 may include an IPO auction in which users may submit bids on each of the one or more players, which may result in an adjustment of each players' initial book value. During initialization stage 304 and between event stages 306, users may generate a portfolio by trading shares of eligible players on the marketplace. During each event stage 306, users wage a predefined percentage of their players' book values. Each player's book value may fluctuate based on the player's performance in the event. During payout stage 308, each end user may receive the current book value as compensation for each respective player. For example, a user owns 10 shares of QB1 having a current book value of $3.50, the user will receive $35.00 at payout stage 308.

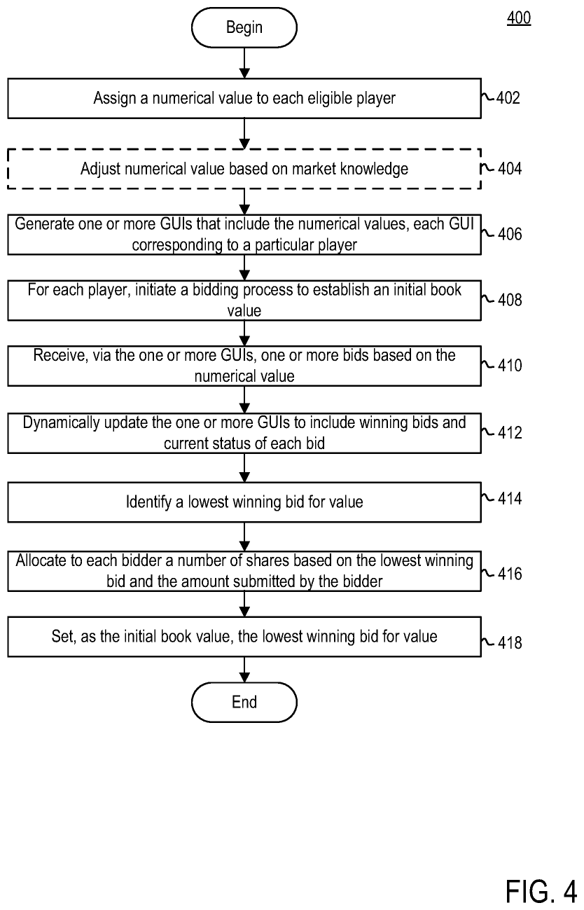

FIG. 4 is a flow diagram illustrating a method 400 of generating a book value for each eligible athlete, according to example embodiments. Method 400 may begin at step 402.

At step 402, marketplace engine 202 may assign a numerical value to each eligible player. For example, marketplace engine 202 may assign an initial book value to each eligible player based, in part, on historical performance of the player. Generally, the initial book value may be a quantitative/numerical value assigned to each eligible athlete in the marketplace prior to the market opening. Marketplace engine 202 may generate the initial book value using a prediction model generated by machine learning module 212. For example, marketplace engine 202 may generate the initial book value of each athlete based on historical performance of each athlete, historical performance of each athlete relative to other eligible athletes, third-party rankings, and the like.

In some embodiments, method 400 may include step 404. At step 404, a market maker may adjust the initial book value based on knowledge of the market. In some embodiments, a market maker may determine that a particular player may be valued too high or too low heading into an IPO auction. For example, assume that QB1 has an initial book value of $2.30/share. A market maker may adjust the initial book value to $2.45/share because, based on the market maker's knowledge, QB1 will sell higher than the generated initial book value. Similarly, assume that WR1 has an initial book value of $2.45/share. A market maker may adjust the initial book value down to $2.00/share because of extrinsic factors associated with the player.

At step 406, interactive gaming platform 116 may generate one or more GUIs corresponding to one or more players. For example, user interface engine 208 may be configured to generate a first GUI providing a list of eligible players. Such list may include a snapshot of the player's stats, as well as the initial book value for the player. User interface engine 208 may further generate one or more second GUIs. Each second GUI may be dedicated to a particular player. For example, upon a user interacting with the first GUI by selecting a particular eligible player, a second GUI may be displayed to the user. The second GUI may allow the user to provide one or more bids on the selected player. In some embodiments, the second GUI is a dedicated window. In some embodiments, the second GUI is an overlay window layered atop the first GUI.

At step 408, interactive gaming platform 116 may initiate an IPO bidding process for each player to establish an initial book value. For example, marketplace engine 202 may initiate an IPO auction for each eligible athlete. For example, marketplace engine 202 may initiate an IPO auction to establish a book value for each athlete based on the initial book value and participant (i.e., end user) demand. In the IPO auction, marketplace engine 202 may sell stocks related to each eligible athlete. The initial price of the shares may be based off the initial book value generated by marketplace engine 202. In some embodiments, marketplace engine 202 may initiate each IPO bidding process at different times. For example, marketplace engine 202 may initiate each IPO bidding process such that the bidding process for each player does not overlap. In some embodiments, marketplace engine 202 may initiate two or more IPO bidding processes for two or more players at the same time (or substantially the same time). Still further, in some embodiments, marketplace engine 202 may initiate all IPO bidding processes for all players simultaneously.

At step 410, interactive gaming platform 116 may receive, via the one or more GUIs, one or more bids for eligible players. In operation, interactive gaming platform 116 may provide the one or more GUIs generated in step 408 to one or more client devices 102. Each of the one or more client devices 102 may be configured to provide one or more bids for an eligible player via the one or more GUIs provided by interactive gaming platform. For example, a client device 102 may submit a bid on QB1. The initial book value for QB1 (defined above in step 402) may be $2.50/share. The bid from client device 102 may be $2.30 for 10 shares of QB1.

As stated above, multiple auctions may be performed for multiple players simultaneously. Accordingly, marketplace engine 202 may be configured to handle and process each bid in real-time (or near real-time) so as to ensure up-to-date information relating to each users' bids.

At step 412, interactive gaming platform 116 may dynamically update the one or more GUIs to include winning bids and a current status of each bid. For example, as bids are received and processed by marketplace engine 202, marketplace module engine 202 may communicate the bids to user interface module 208, such that user interface module 208 may update one or more GUIs to include the currently winning bid, as well as a status of each individual's bid.

At step 414, interactive gaming platform 116 may identify a winning bid for each IPO auction process. For example, marketplace platform 202 may parse the received bids for each IPO auction process to identify a lowest winning bid. The price of the lowest winning bid is used to set the book value for a particular player.

At step 416, interactive gaming platform 116 may allocate to each bidder a number of shares based on the bidder's submitted bid in light of the lowest winning bid. For example, based on the amount submitted by each end user, marketplace engine 202 may allocate to the end user a number of shares based on the lowest winning bid.

At step 418, interactive gaming platform 116 may set, as the initial book value, the lowest winning bid. For example, marketplace engine 202 may assign to each eligible player the identified lowest winning bid in step 414 as the player's book value. Accordingly, the book value set at step 418 may be used as an initial baseline for the first event in the specified period.

The value contributed during the IPO auction processes may go into a marketplace book value pool and remains in the pool until the end of the specified period.

Each market participant (e.g., each user) now owns stocks in one or more players. The aggregate of a user's stocks may be referred to as a portfolio. The stocks may be traded on the marketplace stock exchange. For example, stocks may be bought or sold for value by anyone with an account with the applicable marketplace, regardless of whether they participated in the IPO auction.

FIG. 5A is a block diagram illustrating a graphical user interface (GUI) 500, according to example embodiments. GUI 500 may include information directed to the trading market in the marketplace. GUI 500 may include one or more graphical elements 502 and 504. Graphical element 502 may include one or more actionable items. Each actionable item may result in the display of information associated with that item. As illustrated, graphical element 502 may include actionable items: “My Account,” “Player,” “Trading Market,” “Schedule/Game Pools,” and “Dividends.”

Graphical element 504 may include information associated with the Trading Market. As illustrated, graphical element 504 may include one or more sub-graphical elements 506-512. Each sub-graphical element 508 may correspond to an eligible player in the marketplace. Sub-graphical element 508 may include information associated with each eligible player. For example, sub-graphical element may include such player information as shares owned, book value, bid price, ask price, last trade price, plus/minus (+/−), low price, and high price.

Sub-graphical element 506 may include one or more filtering options. For example, graphical element 506 may include one or more filtering options, such as, but not limited to share volume, dollar volume, biggest gainers, biggest losers, time period (daily, weekly, monthly, season), and the like.

Sub-graphical element 510 may correspond to a buy actionable item. Sub-graphical element 510 may correspond to a sell actionable item. Selection of sub-graphical element 510 may launch a new window, in which a user may submit bids on a share of a particular player. Selection of sub-graphical 512 may launch a new window, in which a user may submit bids on a share of particular player.

Because the market is constantly moving (i.e., users may constantly buy and sell assets), interface engine 208 may update GUI 502 to include real-time (or near real-time) market information.

FIG. 5B is a block diagram illustrating a graphical user interface (GUI) 520, according to example embodiments. GUI 520 may be generated responsive to a user interacting with graphical element 508 in GUI 500. For example, GUI 520 may include more detailed information about a particular player displayed in GUI 500. GUI 520 may include one or more graphical elements 522-528.

Graphical element 522 may correspond to a banner for GUI 520. For example, graphical element 522 may provide the name, team, position, and number of the selected player. As shown, graphical element 522 includes “Drew Brees”, “#9”, “QB”, “Saints.”

Graphical element 524 may be representative of marketplace statistics of the selected play. As illustrated, graphical element 524 may include marketplace statistics that include, but are not limited to, number of shares the user owns of the player, book value/share value, book value/plus-minus, current bids, current asks, the last trade price, the daily low price, the daily high price, and the daily plus/minus.

Graphical element 526 may be representative of a graph displaying the player's book value over a period of time. As shown, the player's book value may fluctuate throughout the season. Graphical element 526 may include sub-graphical element 530. Sub-graphical element 530 may be representative of a symbol associated with the player winning a performance award. A player may earn a player award by, for example, scoring the most points of all players at a particular position. Winning a performance award results in a monetary award for each user holding shares of the respective player.

Graphical element 528 may be representative of historical statistics associated with the user. As shown, graphical element 528 includes historical statistics from 2011 to 2016. Such statistics may include, but are not limited to, average fantasy points, average game pool, starting book value, ending book value, and player awards earned.

FIG. 5C is a block diagram illustrating a graphical user interface (GUI) 540, according to example embodiments. In some embodiments, such as that shown, may include overlay layer 542 positioned atop GUI 520. GUI 540 may be generated as a result of a user requesting to buy shares of a particular player. As shown, users may enter, via overlay layer 542 a desired bid amount and share amount for the player.

FIG. 5D is a block diagram illustrating a graphical user interface (GUI) 560, according to example embodiments. In some embodiments, such as that shown, may include overlay layer 562 positioned atop GUI 520. GUI 560 may be generated as a result of a user requesting to sell shares of a particular player. As shown, users may enter, via overlay layer 562 a desired ask amount and share amount for the player.

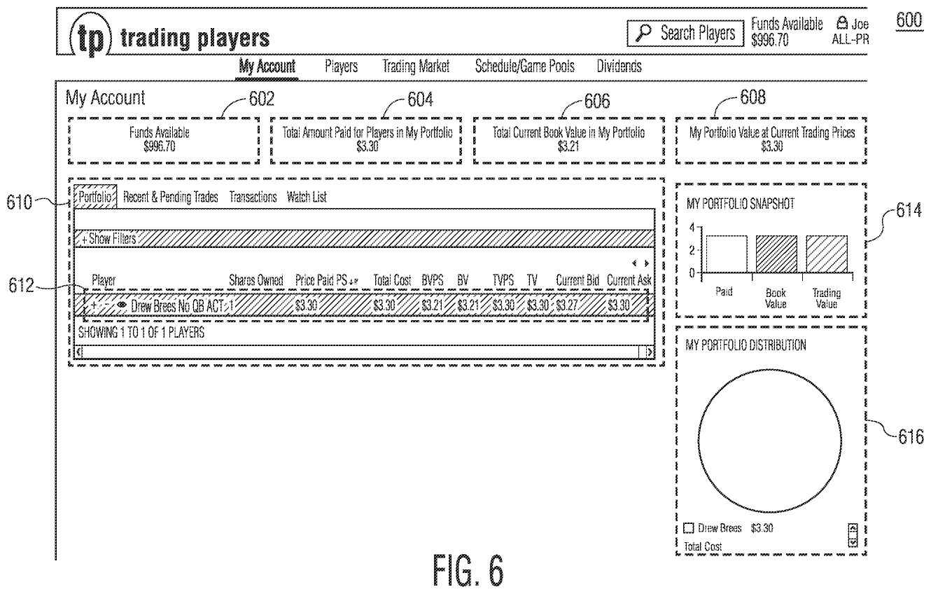

FIG. 6 is a block diagram illustrating a graphical user interface (GUI) 600, according to example embodiments. GUI 600 may be representative of a user profile page. For example, as shown, a user has selected the “My Account” option. GUI 600 may include one or more graphical elements 602-616. Each graphical element 602-616 may represent one or more metrics associated with user's profile.

Graphical element 602 may be representative of an amount of funds the user has available. In some embodiments, each user is provided with a pre-set amount of funds upon registration with organization computing system 104. In some embodiments, each user is provided with a pre-set amount of funds for each marketplace joined. In some embodiments, the users may be provided with an option to purchase more funds.

Graphical element 604 may be representative of a total amount paid for players in the user's portfolio. For example, graphical element 604 may represent the amount spent by the user on assorted players in the user's portfolio. As shown, this user has only spent $3.30.

Graphical element 606 may be representative of the total current book value in the user's portfolio. For example, graphical element 606 may be representative of a sum of all current book values of all players in the user's portfolio. As shown, the total current book value of the user is $3.21.

Graphical element 608 may be representative of the user's portfolio value at the current trading price. For example, graphical element 606 may be representative of the value of the user's portfolio, should the use attempt to sell off the portfolio. Because graphical element 608 is based on current trading prices, those skilled in the art may readily understand that graphical element 608 may dynamically update as the trading prices fluctuate.

Graphical element 610 may be representative of the user's portfolio. For example, graphical element 610 may include one or more sub-graphical elements 612. Each sub-graphical element 612 may correspond to a given player in the users' portfolio. Sub-graphical element 612 may display one or more statistics of the player, such as, but not limited to, shares owned, price paid per share, total cost, daily value per share, daily value, true value per share, true value, current bid price, and current ask price.

Graphical element 614 may be representative of a snapshot of the user's portfolio. As shown, graphical element 614 may represent a bar chart illustrating various statistics associated with the user's portfolio. Each bar may represent a specific statistic. For example, the one or more bars in the bar chart may represent an amount paid, the book value, and the trading value of the portfolio.

Graphical element 618 may be representative of the portfolio's distribution. For example, graphical element 618 may include a pie chart representing the user's portfolio distribution. As shown, the user only has a single share of Drew Brees. Accordingly, the single share makes up 100% of the user's portfolio.

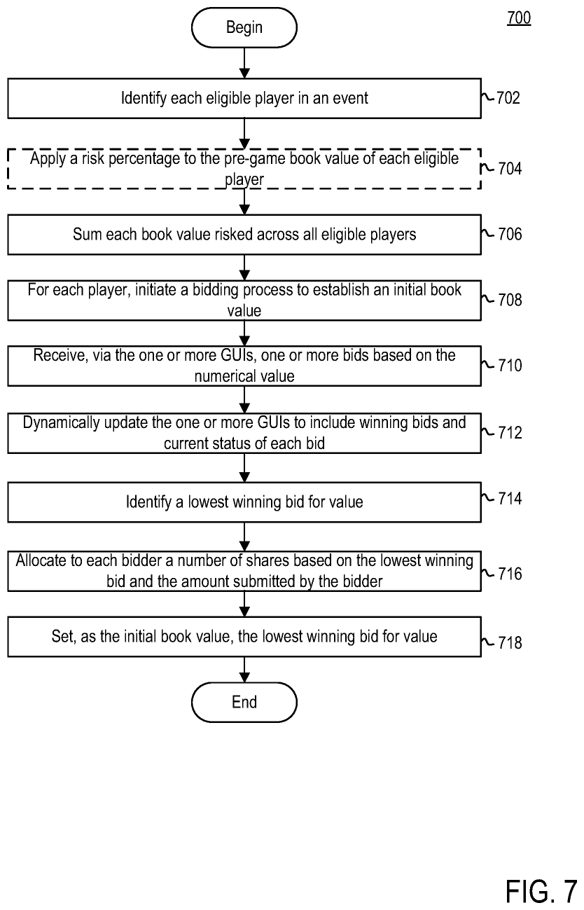

FIG. 7 is a flow diagram illustrating a method 700 of conducting an event in a virtual game space, according to example embodiments. Although the operations provided below are discussed in conjunction with a single event, those skilled in the art understand that such operations may be applied to all events occurring within the various virtual game spaces. Method 700 may begin at step 702.

At step 702, marketplace engine 202 may identify each player eligible for an event in the virtual game space. For example, marketplace engine 202 may identify the one or more teams participating in the event. Marketplace engine 202 may identify those players that are eligible for the event. Players that are eligible for the event may include those players that are able to perform a measurable event, as defined by marketplace engine 202 prior to the specified period. Further, those players that are eligible for the event do not include players that are inactive for the event. Accordingly, players inactive due to injury, suspension, and the like are not eligible for the event.

In some embodiments, those players that are inactive but registered a “did not play” (DNP) may lose the entire book value that was risked during the event. In some embodiments, those players that are inactive but registered a DNP may be processed as if they were inactive. Such constraints may be defined during marketplace initiation by marketplace engine 202, and may be variable based on sport.

At step 704, marketplace engine 202 may apply a predefined risk percentage to the pre-event book value of each eligible player. For example, assume that eligible players QB1 and QB2 have a pre-event book value of $3.17 per share and $2.50, per share respectively. Marketplace engine 202 may risk a predefined percentage of QB1's and QB2's pre-event book value. For example, marketplace engine 202 may risk 10% of QB1's and QB2's pre-event book value. Accordingly, the maximum amount QB1 may lose is 10% of $3.17 (i.e., $0.317 per share); the maximum amount QB2 may lose is 10% of $2.50 (i.e., $0.250 per share).

At step 706, marketplace engine 202 may sum the amount risked by each eligible player. For example, marketplace engine 202 may generate an event pool based on the summation of the amount risked by each individual player. For example, continuing with the above example, if QB1 and QB2 were the only eligible players in the event, the event pool would be the amount risked by QB1 (i.e., $0.317 per share) and the amount risked by QB2 ($0.250 per share), yielding a total amount of $0.567 per share. Following completion of the event, marketplace engine 202 may redistribute the event pool, based on player performance. For example, if QB1 scored 95% of the fantasy points in the event, QB1 would earn 95% of the event pool.

At step 708, scoring engine 214 may receive one or more data streams from one or more external sources 106 during the course of the event. In some embodiments, scoring engine 214 may receive one or more data streams from one or more external sources 106 in real-time (or near real-time). In some embodiments, scoring engine 214 may receive one or more data streams from one or more external sources 106 periodically (e.g., at predefined points of the event). Scoring engine 214 may receive one or more data streams by submitting a GET operation to one or more API endpoints defined at one or more data sources 106.

At step 710, scoring engine 214 may identify one or more measurable events within the one or more data streams. For example, scoring engine 214 may parse the one or more data streams to identify one or more events that may constitute fantasy points in the event. In some embodiments, the one or more events may lead to positive fantasy points (e.g., rushing touchdown, reception, throwing touchdown, field goal, three-pointer, strikeout, birdie, etc.). In some embodiments, the one or more events may lead to negative fantasy points (e.g., sack, interception, fumble, turnover, bogie, etc.).

At step 712, scoring engine 214 may continually sum the fantasy points earned for each player. For example, scoring engine 214 may continually update each player's total fantasy points for the game. In some embodiments, scoring engine 214 may update each player's total fantasy points in real-time (or near real-time). Accordingly, when a user navigates to a webpage associated with the virtual game space, the user may view, in real-time (or near real-time), fantasy point information associated with each player in the event. In some embodiments, scoring engine 214 may update each player's total fantasy points periodically.

At step 714, relative value engine 206 may determine a percentage of total fantasy points each player has earned in the event. For example, relative value engine 206 may continually work with scoring engine 214 to identify a total share of a player's fantasy points in relation to the total fantasy points earned in the contest. In some embodiments, relative value engine 206 may update each player's percentage of total fantasy points in real-time (or near real-time). In some embodiments, relative value engine 206 may update each player's percentage of total fantasy points periodically.

At step 716, relative value engine 206 may allocate the event pool among the one or more eligible players, based on the determined percentage of total fantasy points earned by each player. For example, relative value engine 206 may continually allocate the event pool among the one or more eligible players throughout the event, until the event concludes. In some embodiments, relative value engine 206 may update each player's earnings of the event pool in real-time (or near real-time). Accordingly, when a user navigates to a webpage associated with the virtual game space, the user may view, in real-time (or near real-time) the amount of the event pool earned by each individual player at any given point of the event. In some embodiments, relative value engine 206 may update each player's allocation of the event pool periodically.

At step 718, relative value engine 206 may update each player's book value when the event concludes. For example, after the event concludes, and relative value engine 206 generates the allocation of the event pool due to each player, relative value engine 206 may update each player's pre-event book value. Continuing with the above example, if QB1 ends up receiving 95% of the event pool and QB2 ends up receiving 5% of the event pool, QB1 earns 95% of the $0.567 event pool, or $539; QB2 earns 5% of the $0.567 event pool, or $0.028. Accordingly, QB1 increases the pre-event book value by $0.22, while QB2 decreases the pre-event book value by $0.22. Accordingly, the adjusted book value for QB1 and QB2 may act as the pre-event book value for QB1 and QB2 for a subsequent event.

### Example 1

With the above discussion in mind, assume that an event includes three-eligible athletes: Athlete A, Athlete B, and Athlete C.

| | Pre-Event | Book Value |
|---|---|---|
| Athlete | Book Value | Risked in Event (10%) |
| Athlete A | 40,000 | 4,000 |
| Athlete B | 50,000 | 5,000 |
| Athlete C | 60,000 | 6,000 |
| Total | 150,000 | Event Pool = 15,000 |

The measurable events are defined by marketplace engine 202 as the following:

| Type of Measurable Event | Fantasy Point Value |
|---|---|
| Passing touchdown | 3 points |
| 10 rushing yards | 1 point |
| First down | 1 point |
| 10 receiving yards | .5 each for passer and receiver |

Using the above measurable events, at the conclusion of the event, scoring engine 214 may determine the total fantasy points earned by each athlete as:

| | | Fantasy |
|---|---|---|
| | Measurable | Points |
| Athlete | Event Statistics | earned |
| Athlete A | 1 passing touchdown, | 7 |
| | 40 yards rushing | |
| Athlete B | 30 yards rushing, | 5 |
| | 2 first downs | |
| Athlete C | 60 yards receiving, | 4 |
| | 1 first down | |

Based on the above, relative value engine 206 may determine that the amount of fantasy points earned, in total, during the event is 16. Accordingly, Athlete A earned 43.75% of the fantasy points; Athlete B earned 31.25% of the fantasy points; and Athlete C earned 25% of the fantasy points. As such, Athlete A earned 43.75% of the event pool; Athlete B earned 31.25% of the event pool; and athlete C earned 25% of the event pool. Relative value engine 206 may apply this information to the event pool to determine the amount of the event pool earned by each player. Athlete A earned $2,562.50; Athlete B lost $312.50; and Athlete C lost $2,250.00. Accordingly, Athlete A's book value has changed from a pre-event book value of $40,000 to a post-event book value of $42,562.50; Athlete B's book value changed from $50,000 to $49,687.50; Athlete's C book value changed from $60,000 to $57,750.00.

Accordingly, whatever the game pool is at the end of the event, marketplace engine 202 may distribute the game pool back to the athletes based on the points earned versus the total points earned in the contest.

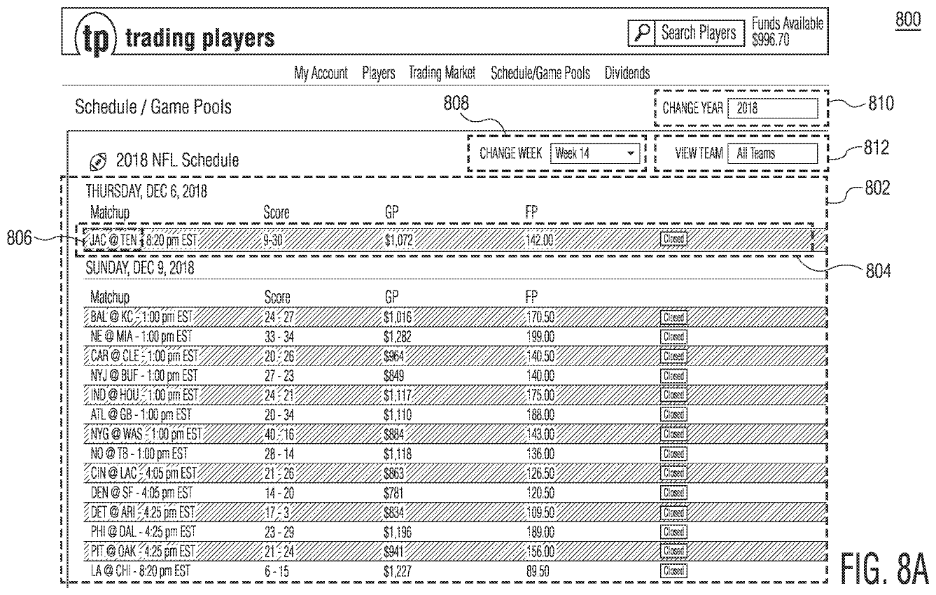

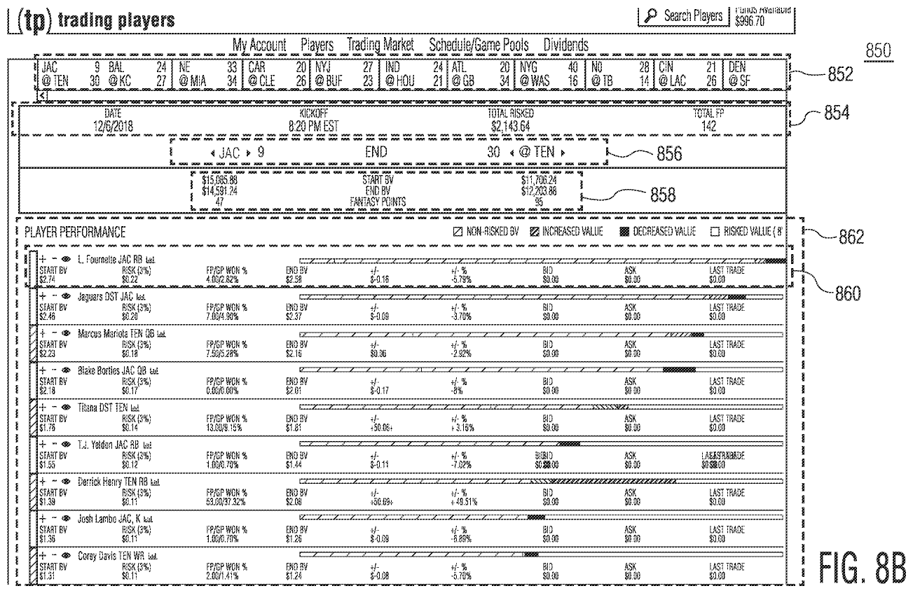

FIG. 8A is a block diagram illustrating a graphical user interface (GUI) 800, according to example embodiments. GUI 800 may be representative of a schedule/game pools page. For example, as shown, GUI 800 may include the various events that are occurring in a given week of competition. GUI 800 may include one or more graphical elements 802-812.

Graphical element 802 may be representative of a list of events occurring during a given week of competition. For example, each graphical element 802 may include one or more graphical elements 804. Each graphical element 804 may correspond to a particular event. For example, graphical element 804, as shown, corresponds to the event: Jacksonville at Tennessee. Each graphical element 804 may include an actionable graphical element 806. Actionable graphical element 806 may be configured to be actionable by the user. For example, upon a user selecting actionable graphical element 806, the user may be led to a page that includes details for the event associated with graphical element 806.

Graphical elements 808-812 may represent one or more filtering options for the one or more events displayed in graphical element 802. Graphical element 808 may correspond to a filtering option that allows the user to filter the events in graphical element 802 by week. Graphical element 810 may correspond to a filtering option that allows the user to filter the events in graphical element 802 by year. Graphical element 812 may correspond to a filtering option that allows the user to filter the events in graphical element 802 by team.

FIG. 8B is a block diagram illustrating a graphical user interface (GUI) 850, according to example embodiments. GUI 850 may be representative of a detailed look at an event displayed in graphical element 802, in response to a user interacting with actionable graphical element 806. For example, as shown, GUI 850 may include one or more details about the Jacksonville at Tennessee game. GUI 850 may include one or more graphical elements 852-862.

Graphical element 852 may be representative of one or more events occurring in a particular week. For example, graphical element 852 may include one or more events in the marketplace that are occurring on the same day as the selected event. Graphical element 854 may include one or more metrics associated with the selected event. For example, graphical element 854 may include the date of the event, the time of the event, the total amount risked in the event, and the total fantasy points scored in the event. Graphical element 856 may include one or more metrics associated with the selected event. For example, graphical element 856 may include the current score of the event. Graphical element 858 may include one or more metrics associated with the selected event. For example, for each team in the event, graphical element 858 may include the starting book value, the ending book value, and the total fantasy points.

Graphical element 862 may include statistics associated with one or more eligible players in the event. For example, graphical element 862 may include one or more graphical element 864. Each graphical element 864 may correspond to a particular player. For example, as shown, graphical element 864 may correspond to Leonard Fournette. Graphical element 864 may provide a visual representation of the player's book value, the amount of book value risked, and the amount of book value lost or earned from the competition. Graphical element 864 may further include the fantasy points earned by the player.

As those skilled in the art may recognize, GUI 850 may dynamically update to reflect current values during game play. For example, graphical element 864 may dynamically update to reflect the current fantasy points scored by each player, as well as the impact of those fantasy points on the player's book value. Thus, users may track player progression throughout the event.

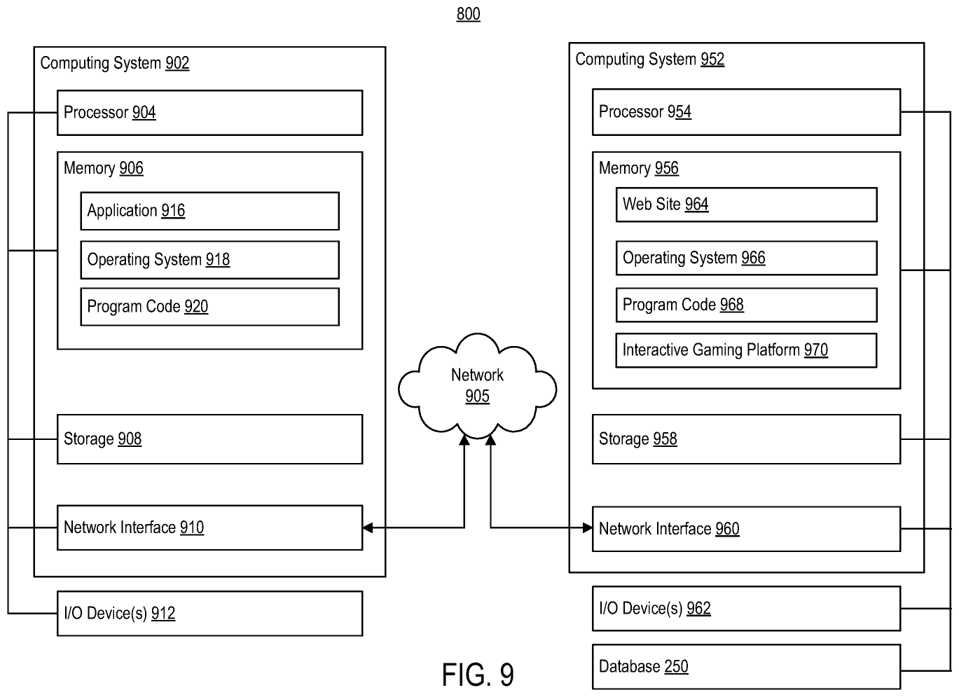

FIG. 9 is a block diagram illustrating an exemplary computing environment 900, according to some embodiments. Computing environment 900 includes computing system 902 and computing system 952. Computing system 902 may be representative of client device 102. Computing system 952 may be representative of organization computing system 104.

Computing system 902 may include a processor 904, a memory 906, a storage 908, and a network interface 910. In some embodiments, computing system 902 may be coupled to one or more I/O device(s) 912 (e.g., keyboard, mouse, etc.).

Processor 904 may retrieve and execute program code 920 (i.e., programming instructions) stored in memory 906, as well as stores and retrieves application data. Processor 904 may be included to be representative of a single processor, multiple processors, a single processor having multiple processing cores, and the like. Network interface 910 may be any type of network communications allowing computing system 902 to communicate externally via computing network 905. For example, network interface 910 is configured to enable external communication with computing system 952.

Storage 908 may be, for example, a disk storage device. Although shown as a single unit, storage 908 may be a combination of fixed and/or removable storage devices, such as fixed disk drives, removable memory cards, optical storage, network attached storage (NAS), storage area network (SAN), and the like.

Memory 906 may include application 916, operating system 918, and program code 920. Program code 920 may be accessed by processor 904 for processing (i.e., executing program instructions). Program code 920 may include, for example, executable instructions for communicating with computing system 952 to display one or more pages of website 964. Application 916 may enable a user of computing system 902 to access a functionality of computing system 952. For example, application 916 may access content managed by computing system 952, such as website 964. The content that is displayed to a user of computing system 902 may be transmitted from computing system 952 to computing system 902, and subsequently processed by application 916 for display through a graphical user interface (GUI) of computing system 902.

Computing system 952 may include a processor 954, a memory 956, a storage 958, and a network interface 960. In some embodiments, computing system 952 may be coupled to one or more I/O device(s) 962. In some embodiments, computing system 952 may be in communication with database 250.

Processor 954 may retrieve and execute program code 968 (i.e., programming instructions) stored in memory 956, as well as stores and retrieves application data. Processor 954 is included to be representative of a single processor, multiple processors, a single processor having multiple processing cores, and the like. Network interface 960 may be any type of network communications enabling computing system 952 to communicate externally via computing network 905. For example, network interface 960 allows computing system 952 to communicate with computer system 902.

Storage 958 may be, for example, a disk storage device. Although shown as a single unit, storage 958 may be a combination of fixed and/or removable storage devices, such as fixed disk drives, removable memory cards, optical storage, network attached storage (NAS), storage area network (SAN), and the like.

Memory 956 may include website 964, operating system 966, program code 968, and interactive gaming platform 970. Program code 968 may be accessed by processor 954 for processing (i.e., executing program instructions). Program code 968 may include, for example, executable instructions configured to perform steps discussed above in conjunction with FIGS. 2-5. As an example, processor 954 may access program code 968 to perform operations associate with generation and management of an interactive game space. In another example, processor 954 may access program code 968 to perform operations for generating one or more GUIs for various stages of each virtual game space. Website 964 may be accessed by computing system 902. For example, website 964 may include content accessed by computing system 902 via a web browser or application.

Interactive gaming platform 970 may be configured to manage one or more skill-based fantasy sport games. For example, interactive gaming platform 970 may be configured to generate a virtual sport-based marketplace that facilitates a fantasy sports competition. Users may register and/or login with interactive gaming platform 970 to gain access to the virtual sports-based marketplace. Upon registering and/or logging in, each user (or market participant) may invest in one or more athletes. Such investment may be tied to an athlete's (or player's) on-field performance in a competitive contest. The virtual sports-based marketplace may be configured for the issuance and trading of “stocks” (i.e., shares of an athlete/player) for particular sports covering individual seasons, portions of a season (e.g., post-season, playoffs, half-season, quarter-season, daily fantasy), a specific event (e.g., Olympics, golfing majors, tennis majors, etc.), multiple seasons, and the like. During each specified period, users may trade stock in a manner similar to financial instruments.

While the foregoing is directed to embodiments described herein, other and further embodiments may be devised without departing from the basic scope thereof. For example, aspects of the present disclosure may be implemented in hardware or software or a combination of hardware and software. One embodiment described herein may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid state random-access memory) on which alterable information is stored. Such computer-readable storage media, when carrying computer-readable instructions that direct the functions of the disclosed embodiments, are embodiments of the present disclosure.

It will be appreciated to those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

What is claimed is:

1. A system, comprising:
a processor; and
a memory having programming instructions stored thereon, which, when executed by the processor, performs one or more operations comprising:
generating a virtual gaming environment, the virtual gaming environment defined a plurality of data objects corresponding to a plurality of eligible players within the virtual gaming environment, the generating comprising:
generating the plurality of data objects corresponding to the plurality of eligible players by:
identifying historical performance data of each eligible player of the plurality of eligible players, this historical performance data corresponding to historical player performance within prior virtual gaming environments,
identifying historical statistical information of each eligible player, the historical statistical information corresponding to real-world performance data,
generating an initial value for each eligible player by inputting the historical performance data and the historical statistical information into a trained machine learning model configured to generate the initial value, and
assigning each initial value to a corresponding data object of the plurality of data objects;
defining a plurality of playable events within the virtual gaming environment, wherein the plurality of playable events corresponds to a plurality of real-world events, wherein an occurrence of a playable event in the real-world can increase or decrease the initial value of a given data object;
initiating an event in the virtual gaming environment, wherein the event comprises a subset of the plurality of data objects;
monitoring an external data feed to identify real-world events within a live event;
detecting a real-world event in the external data feed; and
upon detecting the real-world event in the external data feed, adjusting the initial value of a given data object.

2. The system of claim 1, wherein adjusting the initial value of the given data object comprises:
assigning one or more points to a user associated with the data object in accordance with the playable event corresponding to the real-world event.

3. The system of claim 1, further comprising:
for each data object, risking a portion of an initial value corresponding to the data object.

4. The system of claim 3, wherein adjusting the initial value of the given data object comprises:
allocating to the given data object a portion of a total points in the event based on the portion of the initial value that was risked.

5. The system of claim 1, wherein adjusting the initial value of the given data object comprises:
generating a post-event value for the data object based, wherein the post-event value is applied to the given data object in a subsequent event.

6. The system of claim 1, wherein generating the initial value for each eligible player further comprises:
determining a user demand for each eligible player.

7. The system of claim 1, further comprising:
transferring a data object from a first user to a second user.

8. A computer-implemented method comprising:
generating, by a computing system, a virtual gaming environment, the virtual gaming environment defined a plurality of data objects corresponding to a plurality of eligible players within the virtual gaming environment, the generating comprising:
generating, by the computing system, the plurality of data objects corresponding to the plurality of eligible players by:
identifying historical performance data of each eligible player of the plurality of eligible players, this historical performance data corresponding to historical player performance within prior virtual gaming environments,
identifying historical statistical information of each eligible player, the historical statistical information corresponding to real-world performance data,
generating an initial value for each eligible player by inputting the historical performance data and the historical statistical information into a trained machine learning model configured to generate the initial value, and
assigning each initial value to a corresponding data object of the plurality of data objects;
defining, by the computing system, a plurality of playable events within the virtual gaming environment, wherein the plurality of playable events corresponds to a plurality of real-world events, wherein an occurrence of a playable event in the real-world can increase or decrease the initial value of a given data object;
initiating, by the computing system, an event in the virtual gaming environment, wherein the event comprises a subset of the plurality of data objects;
monitoring, by the computing system, an external data feed to identify real-world events within a live event;
detecting, by the computing system, a real-world event in the external data feed; and
upon detecting the real-world event in the external data feed, adjusting, by the computing system, the initial value of a given data object.

9. The computer-implemented method of claim 8, wherein adjusting, by the computing system, the initial value of the given data object comprises:
assigning one or more points to a user associated with the data object in accordance with the playable event corresponding to the real-world event.

10. The computer-implemented method of claim 8, further comprising:
for each data object, risking, by the computing system, a portion of an initial value corresponding to the data object.

11. The computer-implemented method of claim 10, wherein adjusting, by the computing system, the initial value of the given data object comprises:
allocating to the given data object a portion of a total points in the event based on the portion of the initial value that was risked.

12. The computer-implemented method of claim 8, wherein adjusting, by the computing system, the initial value of the given data object comprises:
generating a post-event value for the data object based, wherein the post-event value is applied to the given data object in a subsequent event.

13. The computer-implemented method of claim 8, wherein generating, by the computing system, the initial value for each eligible player further comprises:
determining a user demand for each eligible player.

14. The computer-implemented method of claim 8, further comprising:
transferring, by the computing system, a data object from a first user to a second user.

15. A non-transitory computer readable medium comprising one or more sequences of instructions, which, when executed by a processor, causes a computing system to perform operations comprising:
generating, by the computing system, a virtual gaming environment, the virtual gaming environment defined a plurality of data objects corresponding to a plurality of eligible players within the virtual gaming environment, the generating comprising:
generating, by the computing system, the plurality of data objects corresponding to the plurality of eligible players by:
identifying historical performance data of each eligible player of the plurality of eligible players, this historical performance data corresponding to historical player performance within prior virtual gaming environments,
identifying historical statistical information of each eligible player, the historical statistical information corresponding to real-world performance data,
generating an initial value for each eligible player by inputting the historical performance data and the historical statistical information into a trained machine learning model configured to generate the initial value, and
assigning each initial value to a corresponding data object of the plurality of data objects;
defining, by the computing system, a plurality of playable events within the virtual gaming environment, wherein the plurality of playable events correspond to a plurality of real-world events, wherein an occurrence of a playable event in the real-world can increase or decrease the initial value of a given data object;
initiating, by the computing system, an event in the virtual gaming environment, wherein the event comprises a subset of the plurality of data objects;
monitoring, by the computing system, an external data feed to identify real-world events within a live event;
detecting, by the computing system, a real-world event in the external data feed; and
upon detecting the real-world event in the external data feed, adjusting, by the computing system, the initial value of a given data object.

16. The non-transitory computer readable medium of claim 15, wherein adjusting, by the computing system, the initial value of the given data object comprises:
assigning one or more points to a user associated with the data object in accordance with the playable event corresponding to the real-world event.

17. The non-transitory computer readable medium of claim 15, further comprising:
for each data object, risking, by the computing system, a portion of an initial value corresponding to the data object.

18. The non-transitory computer readable medium of claim 17, wherein adjusting, by the computing system, the initial value of the given data object comprises:
allocating to the given data object a portion of a total points in the event based on the portion of the initial value that was risked.

19. The non-transitory computer readable medium of claim 15, wherein adjusting, by the computing system, the initial value of the given data object comprises:
generating a post-event value for the data object based, wherein the post-event value is applied to the given data object in a subsequent event.

20. The non-transitory computer readable medium of claim 15, wherein generating, by the computing system, the initial value for each eligible player further comprises:
determining a user demand for each eligible player.
